(19) United States
(12) Patent Application Publication
(10) Pub. No.: US 2005/0213486 A1
(43) Pub. Date: Sep. 29, 2005

(54) Optical recording medium and manufacturing method thereof

(75) Inventors: Noriko Inoue, Odawara-shi (JP); Hiroaki Takano, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/043,305

(22) Filed: Jan. 27, 2005

(30) Foreign Application Priority Data
Mar. 26, 2004 (JP) 2004-092849

(51) Int. Cl. G11B 7/26

(52) U.S. Cl. 369/283; 369/94; 369/288

(57) ABSTRACT

A manufacturing method of an optical recording medium comprises the processes of repeating not less than twice a treatment of coating an embrocation containing an optical recording material with a thickness not more than 150 μm on a transparent support of a thickness of 10 to 200 μm, then of drying a coated film till a solvent content in the coated film becomes not more than 10 mass %, and of forming an optical recording material layer till a total thickness of an optical information recording layer composed of a plurality of the optical recording material layers formed on the transparent support becomes not less than 150 μm; thus forming a lamination body; shaping the obtained lamination body into a predetermined form; and laminating the shaped lamination body with a substrate so that the optical information recording layer is provided between the transparent support and the substrate.

### BACKGROUND OF THE INVENTION

1. Field of the Invention

The present invention relates to an optical recording medium and a manufacturing method thereof, and in particular, to the optical recording medium and manufacturing method thereof which are used for a three-dimensionally optical recording such as a multilayered optical memory and a hologram memory and have an optical information recording layer having a comparative thickness.

2. Description of the Related Art

In an optical recording medium recording information by a multilayered optical memory, a hologram memory, and the like, recording the information is performed not only in a surface direction but also in a depth direction of the recording medium. That is, by utilizing the surface and depth direction (thickness direction of the medium) of an information recoding area provided in the recording medium and recording an information signal three-dimensionally, a high density and large capacity of information recording becomes possible. For example, as an optical recording medium using the hologram is developed a hologram optical recording medium of a multi-recording system that enables a large capacity of information recording by utilizing the thickness direction (depth direction) of a recording medium and three-dimensionally writing interference patterns. In addition, it is also known an optical recording medium that enables a large capacity of three-dimensional information recording by utilizing a non-resonance concurrent absorption process, where a molecule concurrently absorbs two photons and is excited, and recording the information signal also in the depth direction. In these optical recording media, because the information signal is also written in the depth direction (thickness direction), a comparatively thick optical information recording layer becomes necessary.

But in a manufacturing method of a conventional optical recording medium it is difficult to form an optical recording medium layer that is uniform and comparatively thick. For example, conventionally, in accordance with a spin coat method generally used as a method for forming an information recording layer in a disc-like recording medium, a thin layer of not more than 10 μm could be formed. However in the spin coat method it is difficult to uniformly form a thick information recording layer not less than 100 μm. For example, if rotating a substrate at a low speed in order to thickly coat an optical recording material on a substrate surface, a coating film consisting of the optical recording material formed on the substrate results in becoming thick in an edge portion, and it becomes difficult to form a uniform thickness of an information recording layer. In addition, although a method of adjusting a viscosity of coating liquid containing the optical recording material can also be thought, there are many difficult cases, considering an influence on properties of the medium.

In addition, like making of a flexible disk, there is also a method of making a medium with punching out a recording medium into a disk form after coating a recording material on a comparatively thick support. But even if in this case a coating speed is made slow, it is difficult to coat the recording medium not less than 100 μm in thickness on the support.

Consequently, in order to make the optical recording medium having the comparatively thick information recording layer, in claims 1 and 2 and FIG. 1 of Japanese Patent Laid-Open Publication 2001-005368 is proposed a method of laminating two transparent substrates through a spacer and then forming the information recording layer with injecting/hardening a photocured or hot cured resin as an optical recording material into a space formed between the two transparent substrates. But because when in this method the photocured or hot cured resin is solved in a solvent and injected in the space in forming the information recording layer, it is difficult to remove the solvent from between the two transparent substrates, the method cannot be practically applied. In addition, because when a viscosity of the photocured or hot cured resin material injected into the space between the two transparent substrates in order to form the information recording layer is high, it is expected that the injection of the resin material is difficult; additionally, because it is difficult and also takes cost to make a distance between the two transparent substrates uniform, it is not realistic.

Furthermore, in a non-patent document (Yoshimasa Kawata, Optronics, No. 11, 138-142, 2001) is proposed a recording medium where a recording layer and non-recording layer are alternately laminated. But in the recording medium there is a problem that the recording layer and non-recording layer are both not more than 10 μm and thin, and therefore, many layers must be laminated in order to obtain a thick recording layer, and that it is technically difficult to laminate each layer as a uniform film thickness by many layers.

In addition, in claim 1, paragraph [0030], and FIG. 3 of Japanese Patent Laid-Open Publication 2000-105529 is proposed an optical recording medium where an optical recording layer consisting of a light sensitive material is laminated by not less than two layers through a non-recording layer consisting of a light transmissive material. After spin-coating the light transmissive material on a substrate and forming the recording layer, the optical recording medium is manufactured by thermocompressing a support consisting of the light transmissive material on the recording layer, forming the non-recording layer, and further sequentially forming the recording layer with the spin-coat and the non-recording layer with the thermocompression on the non-recording layer. But because after the formation of the recording layer the process of thermocompressing the support is repeated many times, it takes cost. In addition, there is such a problem that in the thermocompression process a position displacement occurs for the each non-recording layer formed, edges of the laminated recording layer and non-recording layer are displaced, and thus the edge displacement gives a bad influence on the formation of the recording layer by the spin coat.

Consequently, it is strongly requested that a manufacturing method of an optical recording medium has an optical recording medium layer with a comparative thickness, thereby is excellent in recording properties, and enables a high density and large capacity of three-dimensionally optical recording.

### SUMMARY OF THE INVENTION

In order to solve problems described above, an manufacturing method of an optical recording medium of the present invention comprises the processes of: (1) repeating not less than twice a treatment of coating an embrocation containing an optical recording material with a thickness not more than 150 μm on a transparent support of a thickness of 10 to 200 μm, then of drying a coated film till a solvent content in the coated film becomes not more than 10 mass %, and of forming an optical recording material layer till a total thickness of an optical information recording layer composed of a plurality of the optical recording material layers formed on the transparent support becomes not less than 150 μm, and thus forming a lamination body; (2) shaping the obtained lamination body into a predetermined shape; and (3) laminating the shaped lamination body on a substrate so as to be provided between the transparent support and the substrate.

In the manufacturing method of the optical recording medium a plurality of the recording material layers composing the optical information recording layer may be formed of any of a same composition and material and a different composition and material.

In accordance with the method can be manufactured the optical recording medium having the optical recording material layer with a total thickness of not less than 150 μm between the transparent support and the substrate by repeating the process (1) and laminating the plurality of the optical recording material layers.

In the present invention the “optical recording medium” means a recording medium that can record an information signal in the optical recording material layer and read the recorded information signal by light. For example, the optical recording medium means a recording medium that can record optical information and read the recorded information by physical and chemical mechanisms such as holography and two-photon absorption.

### BRIEF DESCRIPTION OF THE DRAWINGS

FIG. 1 is a schematic section drawing showing a structure of an optical recording medium related to an embodiment of the present invention.

FIGS. 2A to 2D are drawings illustrating a manufacturing method of an optical recording medium of the present invention in turn.

FIG. 3 is a schematic drawing illustrating a measurement method of a diffraction efficiency.

### DESCRIPTION OF THE PREFERRED EMBODIMENTS

Here will be described an embodiment of the present invention, referring to attached drawings.

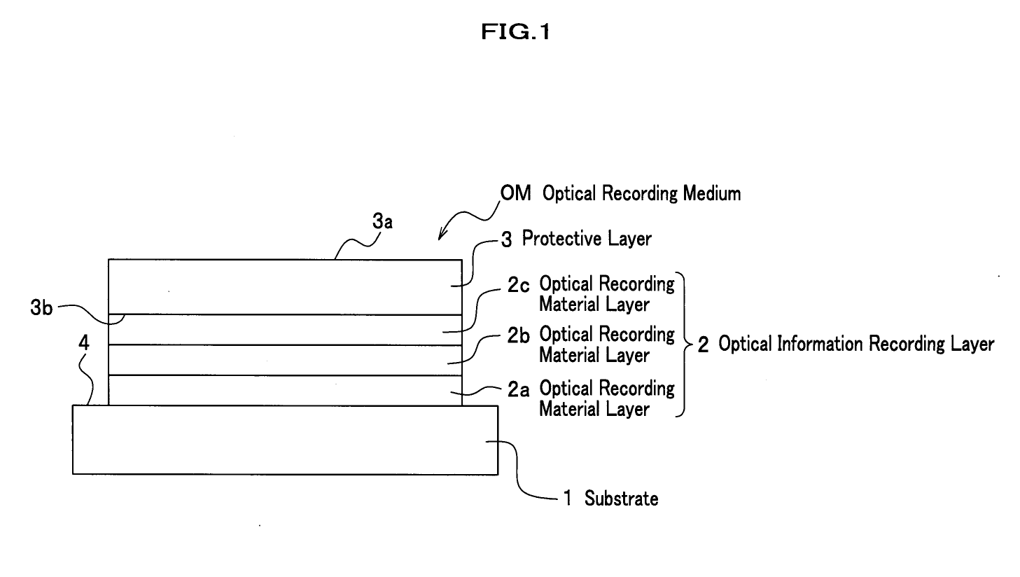

FIG. 1 is a schematic section drawing showing a lamination structure of an optical recording medium OM obtained by an embodiment of a manufacturing method of an optical recording medium of the present invention.

The optical recording medium OM shown in FIG. 1 comprises a substrate 1, an optical information recording layer 2 laminated on the substrate 1, and a protective layer 3.

The substrate 1 is not specifically limited and composed of any of a film and sheet consisting any of a natural and organic synthetic resin. For example, there are cited an inorganic substance such as glass, and an organic synthetic resin such as a polycarbonate, polyethylene terephthalate, triacetylcellulose, acrylic resin, methacrylic resin, polystyrene resin, vinyl chloride resin, epoxy resin, polyester resin, and amorphous polyolefin. Out of these, in applying the optical recording medium of the present invention to any of an optical recording medium for recording information using a hologram (hereinafter referred to as “hologram optical recording medium”) and an optical recording medium for recording the information using a many-photon absorption such as a two-photon absorption (hereinafter referred to as “many-photon absorption optical recording medium”), a material having a low shrinkage percentage, a high transmittance in a recording wavelength, and a low double refraction is preferable, to be more preferably, glass and polycarbonate are preferable.

The substrate 1 may provide a reflective layer on an obverse 4′ contacting the optical information recording layer 2, and the reflective layer is preferable to be formed, using an element such as Cr, Au, Ag, Al, Cu, Pt, Ni, Si, and Ge independently or using something spattered in a state of containing another element. In addition, a surface uniformity of the substrate 1 is preferably not more than λ/4 in a thickness variation for an optical wavelength λ used for recording/reading optical information, and more preferably not more than λ/10.

In addition, because the substrate 1 holds a comparatively thick optical information recording layer, it is preferable to be comparatively thick, for example, an extent of 300 to 1500 μm in thickness.

Furthermore, it may be in advance formed on the obverse 4′ contacting the optical information recording layer 2 of the substrate 1: information for performing servo control such as tracking servo and focus servo, a concave/convex pre-format pattern that indicates information for identifying an address of an information recording area, and a servo signal recording area consisting of pits. Thus in the hologram optical recording medium a recording of interference patterns is accurately performed by interferences of a reference beam and information beam in the optical information recording layer 2, and thereby it is enabled to accurately record light information. In addition, also in reproduction it is enabled to accurately reproduce the optical information by the reference beam. Also in the many-photon absorption optical recording medium the accurate recording/reproducing is enabled by a formation of the pre-format pattern and servo signal recording area.

The optical information recording layer 2 comprises three layers of optical recording material layers 2a, 2b, and 2c consisting of an optical recording material.

Each of the optical recording material layers 2a, 2b, and 2c is formed of the optical recording material whose optical properties such as a refractivity, permittivity, reflectivity, and absorptivity change corresponding to intensity of laser beams when they (reference beam and information beam) are radiated.

As an optical recording material thereof can be used any of two-photon and many-photon absorption optical recording materials for recording information by two-photon absorption or many-photon absorption, a hologram optical recording material for recording the information by a hologram.

The two-photon and many-photon absorption optical recording materials are materials that can record the information by absorbing not less than two photons and causing some chemical or physical change. As the two-photon and many-photon absorption optical recording materials can be cited following things:
(a) a compound that causes some chemical or physical change by absorbing two photons or many photons (hereinafter referred to as “two-photon or many-photon absorption compound”);
(b) a constituent containing a two-photon absorption compound or a many-photon absorption compound, a second compound where some chemical or physical change is induced by absorbing two photons or many photons, and furthermore, a third compound where some chemical or physical change is induced by receiving some chemical or physical reaction from the second compound; and
(c) a constituent containing any of the two-photon absorption compound and the many-photon absorption compound, the second compound where some chemical or physical change is induced by absorbing two photons or many photons, and further a third compound having a role of adjusting an action of information recording by the two-photon absorption compound or the many-photon absorption compound and the second compound.

As the optical recording material, for example, can be cited something containing a compound, which is described in Japanese Patent Laid-Open Publication No. 2002-172864 and the like, as a two-photon or many-photon absorption compound.

In addition, in a case of a hologram optical recording medium, a hologram optical recording material is used as an optical recording material. The hologram optical recording material can be used something where a material property changes along darkness/lightness of interference patterns formed within a recording material, for example, something where a reflectivity difference and a refractivity difference occur.

As a concrete example of the optical recording medium for the hologram optical recording material can be cited silver halide or bichromate gelatin, a photorefractive material, a photochromic material, a photopolymer material, and the like. Out of these, the photopolymer material has advantages that it can obtain a high diffraction efficiency, is low in a noise, and is good in storage stability if completely fixed after recording. The photopolymer material usually contains a binder, a monomer, a sensitizing dye, a polymerisation initiator, and the like. It is desirable to use the binder and monomer having different refractivities. If in recording optical information in a hologram optical recording medium interference patterns are formed within an optical medium, the sensitizing dye is excited at a light portion of interference patterns and emits electrons. The emitted electrons move to the polymerisation initiator and generate radicals; and the radicals move to the monomer, and thereby the polymerisation is initiated. Some monomer causes the polymerisation by an acid generation agent. As the result, the photopolymer material becomes a configuration of the monomer being rich at the light portion of the interference patterns and the binder being rich at the dark portion of the interference patterns, and a refractivity difference is recorded within the optical recording medium as the interference patterns. The monomer not used for recording the optical information is totally exposed and fixed, using a laser and a white light source after the recording. In addition, depending on a material, some monomer is fixed with a heat treatment.

In addition, other than the materials described above, if a material property changes along the lightness/darkness of the interference patterns and a material generates a refractivity difference and a transmittance difference, it can be used as a hologram optical recording material. For example, it can be used something that generates the refractivity difference, accompanying dye coloring and dye vanishing. In addition, as the hologram optical recording material can also be used these combinations, for example, combinations of a dye that colors or vanishes color by light radiation and a constituent containing a photopolymer; a photorefractive material and the constituent containing the photopolymer; and the like.

Theses optical recording materials may appropriately contain something regularly used for forming an optical information recording layer of this kind of an optical recording medium such as a compound having a scattering preventive function, a bonding agent, photo polymerisation initiator, sensitizing dye, optical whiteness increase agent, ultraviolet ray absorber, and thermal stabilizer.

23

In addition, a total thickness of the optical information recording layer 2 is not less than 150 μm and preferably not less than 500 μm. If no more than 150 μm, it becomes difficult to perform the three-dimensional recording of the high recording density and high recording capacity such as the hologram memory and two-photon absorption memory.

In addition, each thickness of the optical recording material layers 2a, 2b, 2c . . . composing the optical information recording layer 2 is not specifically limited and may be same or different if the total thickness of the optical information recording layer 2 is not less than 150 μm. Particularly, in a case of an optical recording medium of a large capacity (not less than 500 GB), it is preferable to make a total thickness (2a+2b+2c . . . ) of the optical information recording layer 2 not less than 500 μm.

In addition, the protective layer 3 is laminated above the optical information recording layer 2, and as described later, has a role of a transparent support of the formed optical recording material layers 2a, 2b, and 2c in a formation of the optical information recording layer 2 and another role of a light lead path for transmitting incident lights from outside of the protective layer 3 and leading them to the optical information recording layer 2. The protective layer 3 is preferable to be formed of a low double refractivity material having a low shrinkage percentage and a high transmittance in a recording wavelength, and. For example, polycarbonate and triacetylcellose are preferable as the low double refractivity material.

In addition, a thickness of the protective layer 3 is 10 to 200 μm and preferably 20 to 100 μm. And a thickness uniformity of the protective layer 3 is preferable to be not more than λ/4 in a thickness variation for a light wavelength λ used for recording/reproducing optical information, and more preferably not more than λ/10.

If the thickness variation exceeds λ/4, a phase of incident lights displaces, and there is a fear of causing a deterioration of a recoding property of an optical recording medium. Usually, the thickness variation appears in a surface roughness Ra (average roughness) of surfaces 3a and 3b of the protective layer 3.

In the optical recording medium OM of the present invention, the substrate 1 and the optical information recording layer 2 may be according to any of modes: (1) the both are laminated each other by thermal lamination; (2) the both are laminated each other through an adhesive layer provided between the both layers; and (3) out of the optical information recording layer 2, the optical recording material layer 2a contacting the substrate 1 contains an adhesive composition and is laminated with the substrate 1 by the adhesive composition. As the adhesive layer or the adhesive composition, for example, can be used a thermoplastic adhesive whose main agent is vinyl acetate, acrylic ester, vinyl chloride, acrylic acid, polyamide, polyester, polyurethane, and the like; a hot cured adhesive of a phenol group and an urea group; a curing agent hardening adhesive of an epoxy group and an isocyanate group; and the like. In addition, other than the hardening adhesive, a gummy agent can be used. As the gummy agent can be used an acryl group, a gum group, a silicone group, and the like.

Meanwhile, although in the embodiment described before the optical recording medium OM having the optical information recording layer 2 composed of the three layers of the optical recording material layers 2a, 2b, and 2c is described, the optical information recording layer 2 is not limited to the layer composed of the three layers of the optical recording material layers 2a, 2b, and 2c shown in FIG. 1; and if the layer has a predetermined thickness of not less than 150 μm composed of a plurality of optical recording material layers, it is not specifically limited, and a number of layers is appropriately decided, depending on a recording system of optical information into an optical recording medium.

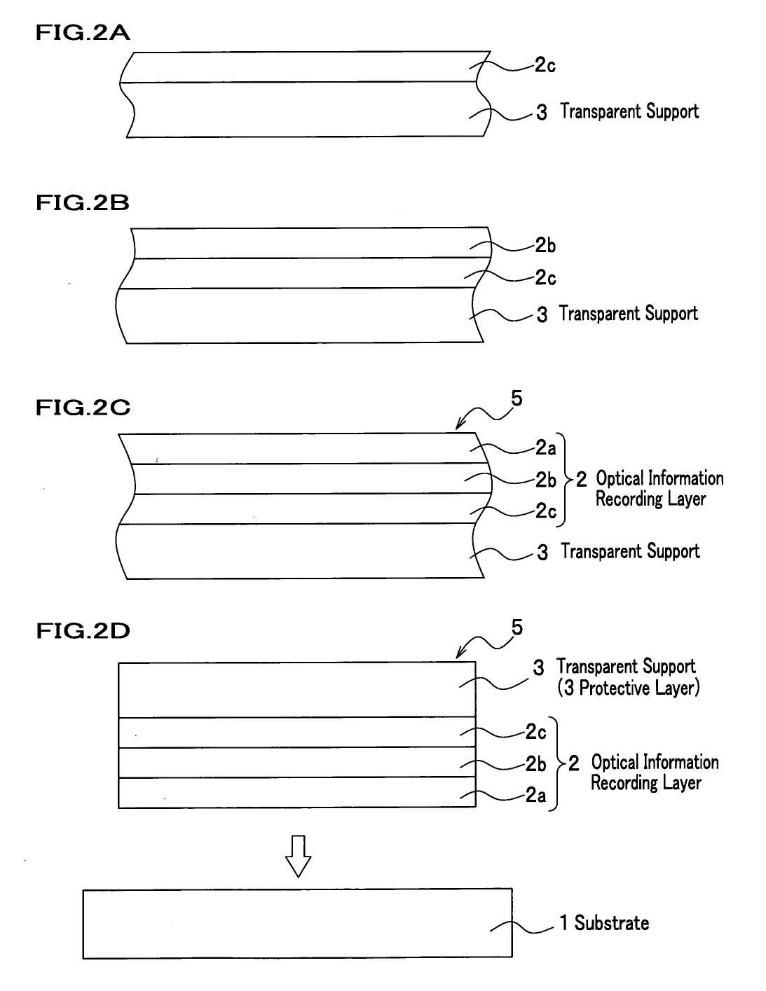

Here will be described a manufacturing method of an optical recording medium of the present invention, taking a method as an example for manufacturing the optical recording medium OM having the optical information recording layer 2 comprising the three layers of the optical recording material layers 2a, 2b, and 2c shown in FIG. 1, referring to FIGS. 2A to 2D.

Firstly as shown in FIG. 2A, after coating an embrocation containing an optical recording material in a thickness not more than 150 μm, dry the coating film till a solvent containment in the coating film becomes not more than 10 mass % and form the optical recording material layer 2c.

Next as shown in FIG. 2B, after coating an embrocation containing an optical recording material in a thickness not more than 150 μm on the optical recording material layer 2c, dry the coating film till a solvent containment in the coating film becomes not more than 10 mass % and form the optical recording material layer 2b.

Furthermore, as shown in FIG. 2C, after coating an embrocation containing an optical recording material in a thickness not more than 150 μm on the optical recording material layer 2b, dry the coating film till a solvent containment in the coating film becomes not more than 10 mass %, form the optical recording material layer 2a, and thus obtain a lamination body 5 of a total thickness of 150 μm having the optical information recording layer 2 comprising the optical recording material layer 2a, 2b, and 2c on a transparent support 3.

The embrocation containing the optical material can be adjusted by mixing a constituent monomer of the photocured or hot cured resin and each constituent appropriately blended such as a bonding agent, photo polymerisation initiator, sensitizing dye, optical whiteness increase agent, ultraviolet ray absorber, and thermal stabilizer; adding a solvent; and agitating them.

It is preferable to adjust the embrocation under lighting of a safety light such as a red lamp in order to prevent the optical recording medium from being cured.

In addition, although a viscosity of the embrocation is appropriately adjusted by a coating method applied, it is usually an extent of 0.1 to 50 Ps. Particularly, when coating the embrocation with using a coater knife such as a doctor knife, the viscosity is preferable to be 1 to 30 Ps.

A coating method of the embrocation onto any of the transparent support 3 and the optical recording material layers 2c and 2d can be performed, using a dip coat method, coater, rod, coil bar, Gieβer, blade instrument, and the like. Particularly, in order to obtain a uniform and thick optical recording material layer, it is preferable to coat the embrocation, using the coil bar or rod.

In addition, in forming the optical information recording layers, drying an embrocation containing an optical recording material can be performed by a method such as a long time drying at a level of a lower temperature giving no damage to the recording material, a vacuum drying, and the like. In addition, the embrocation may be given a degreasing treatment before coating.

Next, shape the lamination body 5 containing the transparent support 3 and the optical information recording layer 2 (optical recording material layers 2a, 2b, and 2c) into a predetermined form by a method like punching, cutting, and the like. The lamination body 5 is shaped into a predetermined form such as a disc form and a card form according to an application such as an optical recording medium and a security medium like an ID card.

Lastly as shown in FIG. 2D, laminate the shaped lamination body 5 with the substrate 1 so that the optical information recording layer 2 is provided between the transparent support 3 and the substrate 1 and so that the optical recording material layer 2a of the optical information recording layer 2 contacts the substrate 1.

A method of laminating the optical information recording layer 2 and the substrate 1 may be any of providing an adhesive layer and gummy layer for thermally sticking the both under the recording layer 2 and laminating the recording layer 2 with the substrate 1; and out of the recording layer 2, adding an adhesive composition in advance to the optical recording material layer 2a contacting the substrate 1, the method may also adhere the both by the adhesive composition.

In accordance with the method whose process is concretely shown in FIGS. 2A to 2D, it is enabled to make an optical recording medium, which has comparatively thick optical information recording layers, easily and at low cost; and in addition, the method is advantageous in a point of making the film thickness of the optical recording layers uniform.

Meanwhile, the method described in FIGS. 2A to 2D in this order is one for indicating a manufacturing method of the three layers of the optical recording material layers 2a, 2b, and 2c shown in FIG. 1; and when manufacturing an optical recording medium having an optical information recording layer comprising not less than four layers of optical recording material layers, the optical information recording layer having a predetermined number of the layers and a predetermined thickness can be formed by repeating the process shown in FIGS. 2A to 2C.

In addition, an optical recording medium may also comprises other layers other than the optical information recording layers, protective layer, adhesive layer, and gummy layer as needed. For example, the optical recording medium may also comprise a reflective layer, dielectric layer, servo information recording layer, and the like.

### EXAMPLE

Next, although examples of the present invention and comparison examples are described, the invention is not limited thereto.

### Example 1

[Adjustment of Embrocation A′]

A binder, a monomer, polymerisation inhibitors (contained in the monomer), a sensitizing dye, and a polymerisation initiator were checkweighed under a red lamp, were put in a brown eggplant-shape flask, dichloromethane was further put in as a solvent, they were stirred for three hours, using a stirrer, and thus an embrocation A′ containing prescribed optical recording materials shown in Table 1 below was obtained. A viscosity of the embrocation A′ was 21 Ps.

TABLE 1

| | Material | Mass Ratio |
|---|---|---|
| Binder | CAB531-1 | 1000 |
| Monomer | POEA | 920 |
| Polymerisation | METQ | 0.276 |
| Inhibitor | | |
| Sensitizing Dye | DEAW | 0.56 |
| Polymerisation | MBO | 36 |
| Initiator | o-CL-HABI | 24 |
| Solvent | Dichloromethane | 6240 |

NB:
CAB531-1, Cellose-Acetate-Butylate (manufactured by Eastman Chemical Co.);
POEA, Acrylic Acid 2-Phenoxyetyl (Cas No. 48145-04-6);
MHEQ, 4-Methoxyphenol (Cas No. 150-76-5);
DEAW, Cyclopentanone-2,5-bis((4-(Diethyl Amino) Phenyl) Methylene) (Cas No. 38394-53-5);
MBO, 2-Melcaptobenzoxazole (Cas No. 2382-96-9); and
o-CL-HABI, 2,2-bis(o-Chlorophenyl)-4,4,5,5-Tetoraphenyl-1, 1-Biimidazole (Cas No. 1707-68-2).

The embrocation A′ was on a transparent support (polycarbonate, thickness 80 μm) with using a coater of a clearance of 300 μm (gap length), and thereby an optical recording material layer of a thickness of 49 μm was formed. Subsequently, a process of coating and drying the embrocation A′ was repeated twice, thereby an optical information recording layer of a total thickness of 147 μm comprising three layers of the optical recording material layers on the support was formed, and thus an optical recording lamination body was obtained. Then the optical recording lamination body was punched out like a diameter of 12 cm of a disc, and thus an optical information recording body was obtained. Then the optical information recording body was laminated with a diameter of 12 cm of a glass substrate (thickness, 1 mm), and thereby an optical recording medium was manufactured. At this time, because the monomer was liquid, it was enabled to laminate the lamination body with the glass substrate without using an adhesive layer and a gummy layer.

### Example 2

[Adjustment of Embrocation B′]

A binder, a dye vanished in color by acid, an acid generation agent, and a sensitizing dye were checkweighed under a red lamp, were put in a brown eggplant-shape flask, a solvent further was put in, they were stirred for three hours, using a stirrer, and thus an embrocation B′ containing prescribed optical recording materials shown in Table 2 below was obtained.

TABLE 2

| | Material | Mass Ratio |
|---|---|---|
| Binder | PMMA | 1000 |
| Dye vanished in color by acid | Dye A” | 157.5 |
| Acid Generation Agent | Acid Generation Agent A’’’ | 500 |
| Sensitizing Dye | Dye B” | 80 |
| Solvent | Methylene Chloride | 3250 |
| Solvent | Acetonitrile | 1052.5 |

NB: PMMA, Polymethylmethacrylate (manufactured Aldrich Inc. Mw:
996000);
Dye A”, a quaternary ammonium salt expressed in a formula (a) below;
Acid Generation Agent A”‘, Diphenyliodonium-
Hexafluorophosphate (Gas No. 58109-40-3); and
Dye B”, Ru complex compound expressed in a formula (b) below.

| | |
|---|---|
| | (a) |
| 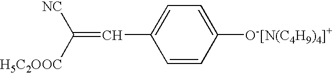 | |
| | (b) |
| 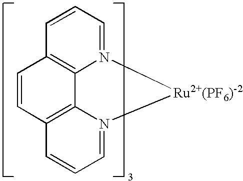 | |

The embrocation B′ was coated on a transparent support (polycarbonate, thickness 30 μm) with using a coater of a clearance of 300 μm (gap length), and thereby an optical recording material layer of a thickness of 49 μm was formed. Subsequently, a process of coating and drying the embrocation B′ was repeated twice, thereby an optical information recording layer of a total thickness of 147 μm comprising three layers of the optical recording material layers on the support was form, and thus an optical recording lamination body was obtained. Then the optical recording lamination body was punched out like a diameter of 12 cm of a disc, and thus an optical information recording body was obtained. Then the optical information recording body was laminated with a diameter of 12 cm of a glass substrate (thickness, 1 mm), and thereby an optical recording medium was manufactured.

In the optical recording material layers formed by the embrocation B′, at a light portion of interference patterns the sensitizing dye A″ was excited by a laser, and electrons were emitted from the excited dye. The emitted electrons moved to the acid generation agent, and an acid was generated by it. By the acid, in color vanished the dye B″ (dye vanished in color by an acid) different from the sensitizing dye A″, and refractivity changed. Thus by vanishing the dye B″ at a light portion of interference patterns, refraction modulation was caused and a hologram was recorded.

### Comparison Example 1

A procedure was made same as in the example 2 except that a transparent support of a thickness of 80 μm made of polyethylene terephthalate was used, a thickness of each optical recording material was made layer 48 μm, and the embrocation B′ was not dried after its coating; and thus an optical recording medium, where a total thickness of optical information recording material layers is 144 μm, was manufactured. But an amount of a residual solvent was large, 15 mass %. In addition, diffraction lights could not be observed from the optical recording medium obtained. It is inferred that this is because an acid generated from the acid generation agent moves to the residual solvent and the dye B also vanishes at a dark portion of interference patterns.

### Comparison Example 2

Once the embrocation A′ was coated through a blade with a clearance of 1 mm on a support (polycarbonate, thickness 80 μm), and a lamination body having an optical recording material layer of a thickness of 147 μm was obtained. At this time, bubbles occurred in drying. The lamination body was punched out like a diameter of 12 cm of a disc, it was laminated with a diameter of 12 cm of a glass substrate (thickness, 1 mm), and thus an optical recording medium was manufactured. Refraction lights could not be observed from the optical recording medium.

[Evaluation]

A diffraction efficiency, a thickness, a number of bubbles, an amount of the residual solvent of the each optical recording medium obtained in each of the examples 1 and 2 and the comparison examples 1 and 2 were measured according to following methods. Results are shown in Table 3.

[Measurement of Diffraction Efficiency]

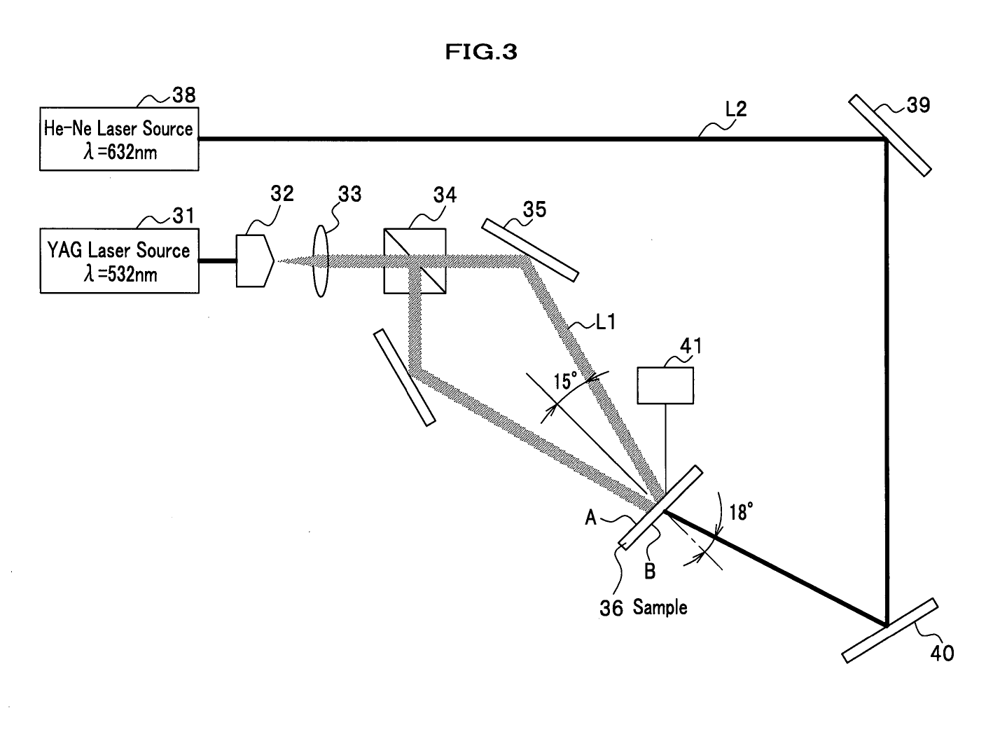

As shown in FIG. 3 was performed a saturation exposure to an obverse A of a sample 36 at an incident angle of 15 degrees, with a spot diameter of 8 mm, and a recording energy of 2000 mJ/cm², using a wavelength of 532 nm of a YAG laser light L1 radiated on the obverse A of the sample 36 from a YAG laser source 31 through an object lens 32, a lens 33, a beam slitter 34, and a mirror 35. At this time was radiated a wavelength of 633 nm of a He—Ne laser light L2 on a reverse B of the sample 36 at an incident angle of 18 degrees from a He—Ne laser source 38 through mirrors 39 and 40, and was observed a change of a diffraction efficiency for an exposure amount. At this time, the diffraction efficiency was obtained according to a below formula from a diffraction light amount of the He—Ne laser measured by a power meter 41 provided at a side of the obverse A of the sample 36 and an incident light amount (outgoing light amount from the He—Ne laser source 38) of the He—Ne laser entering the reverse B of the sample 36:
Diffraction efficiency (%)=a diffraction light amount/an incident light amount×100.
[Thickness Measurement]

A total thickness of the optical information recording layers was measured, using DIGITAL MICROMETER manufactured by SONY CO.

[Measurement of Number of Bubbles]

The optical recording medium was visually observed from a side of the support, and a number of bubbles per 10 cm² was measured.

[Lamination Situation Evaluation]

A visual observation and an evaluation were performed according to a standard below.
Good: a surface after lamination is smooth.
No good: a streak and wrinkle occur in lamination, and a surface is not smooth.
   [Measurement of Residual Solvent]

A part of the optical recording lamination body was sampled just before lamination, the obtained sample was heated at a heating rate of 3 degrees Celsius/min with using TG-DSC (Differential Scanning Calorimeter), and a weight loss amount was measured for a period from a room temperature till heating up to 250 degrees Celsius. Because respective boiling points of dichloromethane and acetonitrile used as the solvent are 40.2 and 82 degrees Celsius, a residual solvent amount was calculated with using a weight loss amount of the sample at 82 degrees Celsius, based on a formula below:
Residual solvent amount (mass %)=(a weight loss amount of a sample/an original weight of the sample)×100.

TABLE 3

| | | | Comparison | Comparison |
|---|---|---|---|---|
| | Example 1 | Example 2 | Example 1 | Example 2 |
| Recording Method | Hologram | Hologram | Hologram | Hologram |
| Prescription | A | B | B | A |
| Support | PC | PC | PET | PC |
| Thickness of | 80 | 30 | 80 | 80 |
| Support (μm) | | | | |
| Thickness of One | 49 | 49 | 48 | 179 |
| Layer of Optical | | | | |
| Recording Material | | | | |
| Layer (μm) | | | | |
| Number of | 3 | 3 | 3 | 1 |
| Laminations | | | | |
| Total Thickness of | 147 | 147 | 144 | 179 |
| Optical Recording | | | | |
| Material Layers | | | | |
| (μm) | | | | |
| Number of Bubbles | 29 | 31 | 31 | 151 |
| Residual Solvent | 6 | 8 | 15 | 10 |
| Amount (mass %) | | | | |
| Diffraction | 1.3 | 1.2 | No | No |
| Efficiency (%) | | | Diffraction | Diffraction |
| | | | Light | Light |

1. A manufacturing method of an optical recording medium comprising the processes of:
(1) repeating not less than twice a treatment of coating an embrocation containing an optical recording material with a thickness not more than 150 μm on a transparent support of a thickness of 10 to 200 μm, then of drying the coated embrocation till a solvent content in a coated film of the coated embrocation becomes not more than 10 mass %, and of forming an optical recording material layer till a total thickness of an optical information recording layer composed of a plurality of said optical recording material layers formed on said transparent support becomes not less than 150 μm, and thus forming a lamination body;
(2) shaping an obtained lamination body into a predetermined form; and
(3) laminating the shaped lamination body with a substrate so that said optical information recording layer is provided between said transparent support and said substrate.

2. A manufacturing method of an optical recording medium according to claim 1, wherein said optical information recording layer is laminated with said substrate by thermal sticking.

3. A manufacturing method of an optical recording medium according to claim 1, wherein said optical information recording layer and said substrate is laminated through any an adhesive layer and a gummy layer.

4. A manufacturing method of an optical recording medium according to claim 1, wherein said optical information recording layer is laminated with said substrate by any of an adhesive constituent and a gummy constituent, and wherein the adhesive constituent is contained by an optical recording material layer contacting said substrate.

5. A manufacturing method of an optical recording medium according to claim 1, wherein said optical recording material is a material whose dye colors or vanishes in color and whose optical property changes in a recording wavelength in response to an intensity of a laser beam when the laser beam is radiated.

6. A manufacturing method of an optical recording medium according to claim 5, wherein said optical recording material is any of a two-photon absorption optical recording material, many-photon absorption optical recording material, and a hologram optical recording material.

7. A manufacturing method of an optical recording medium according to claim 6, wherein any of said two-photon absorption optical recording material and said many-photon absorption optical recording material is any of (a) a compound that causes some chemical or physical change by absorbing two photons or many photons; (b) a constituent containing the two-photon absorption compound or the many-photon absorption compound, a second compound where some chemical or physical change is induced by absorbing two photons or many photons, and furthermore, a third compound where some chemical or physical change is induced by receiving some chemical or physical reaction from the second compound; and (c) a constituent containing the two-photon absorption compound or the many-photon absorption compound, the second compound where some chemical or physical change is induced by absorbing two photons or many photons, and further a third compound having a role of adjusting an action of information recording by the two-photon absorption compound or the many-photon absorption compound and the second compound.

8. A manufacturing method of an optical recording medium according to claim 6, wherein said hologram optical recording material is at least one kind selected from a group comprising silver halide, bichromate gelatin, a photorefractive material, a photochromic material, a photopolymer material.

9. A manufacturing method of an optical recording medium according to claim 8, wherein said optical recording material is a photopolymer material.

10. A manufacturing method of an optical recording medium according to claim 9, wherein said photopolymer material comprises a binder and a monomer having a refractivity different from that of said binder.

11. A manufacturing method of an optical recording medium according to claim 1, wherein a total thickness of an optical information recording layer is not less than 500 μm.

12. A manufacturing method of an optical recording medium according to claim 1, wherein a total thickness of said transparent support is from 10 to 200 μm.

13. A manufacturing method of an optical recording medium according to claim 1, wherein a thickness uniformity of said transparent support is not more than λ/4 in a thickness variation for a light wavelength λ used for recording/reproducing optical information.

14. A manufacturing method of an optical recording medium according to claim 1, wherein a viscosity of said embrocation is from 0.1 to 50 Ps.

15. A optical recording medium comprising:
a substrate;
a transparent support having a thickness of 10 to 200 μm; and
an optical information recording layer provided between said transparent support and said substrate by repeating not less than twice a treatment of coating an embrocation containing an optical recording material with a thickness not more than 150 μm on said transparent support of a thickness of 10 to 200 μm, then of drying a coated film till a solvent content in the coated film becomes not more than 10 mass %, and of forming said optical recording material layer till a total thickness of said optical information recording layer composed of a plurality of said optical recording material layers formed on said transparent support becomes not less than 150 μm,
shaping an obtained lamination body into a predetermined form; and
laminating the shaped lamination body with the substrate.

16. An optical recording medium according to claim 15, wherein said optical recording material is a material whose dye colors or vanishes in color and whose optical property changes in a recording wavelength in response to an intensity of a laser beam when the laser beam is radiated.

17. A manufacturing method of an optical recording medium according to claim 15, wherein a boundary face has a reflective layer between said substrate and said optical information recording.

18. A manufacturing method of an optical recording medium according to claim 15, wherein said substrate has a servo signal recording area on a face in contact with said optical information recording layer.

19. A manufacturing method of an optical recording medium according to claim 15, wherein a total thickness of an optical information recording layer is not less than 500 μm.

20. A manufacturing method of an optical recording medium according to claim 15, wherein a thickness of said transparent support is from 10 to 200 μm.
